(19) United States
(12) Patent Application Publication
(10) Pub. No.: US 2012/0169215 A1
(43) Pub. Date: Jul. 5, 2012

(54) COLOR DISPLAY

(76) Inventors: Yun-I Liu, Hsin-Chu (TW); Chen-Hsien Liao, Hsin-Chu (TW)

(21) Appl. No.: 13/037,380

(22) Filed: Mar. 1, 2011

(30) Foreign Application Priority Data
Dec. 31, 2010 (TW) 099147205

(51) Int. Cl. H01J 1/62

(52) U.S. Cl. 313/504

(57) ABSTRACT

A color display includes a display panel and an organic light-emitting diode. The display panel includes a color filter. The color filter includes a red photoresist, a green photoresist, and a blue photoresist. The blue photoresist is a dye base resist. The organic light-emitting diode backlight source is used for providing a first light source for the display panel. Therefore, the organic light-emitting diode is able to generate a white point of color light which can match a specification through the color filter.

### BACKGROUND OF THE INVENTION

1. Field of the Invention

The present invention is related to a color display, and particularly to a color display having a color filter with a dye based blue photoresist and an organic light-emitting diode, or a color display having a color filter with a dye based and pigment based blue photoresist and an organic light-emitting diode.

2. Description of the Prior Art

Please refer to FIG. 1. FIG. 1 is a diagram illustrating a color display 100 utilizing an organic light-emitting diode (OLED) as a backlight source according to the prior art. As shown in FIG. 1, the color display 100 includes a display panel 102 and an organic light-emitting diode 104, where the organic light-emitting diode 104 is installed below the display panel 102 for providing backlight (white light) BL, and the display panel 102 includes a color filter 1022. The color filter 1022 is divided into a plurality of blocks; each block of the plurality of blocks corresponds to a pixel and includes a red photoresist, a green photoresist, and a blue photoresist. White light transmitted by the organic light-emitting diode 104 provides red light, green light, and blue light for the display panel 102 through the color filter 1022. In addition, FIG. 1 only shows a red photoresist 10222, a green photoresist 10224, and a blue photoresist 10226 of a block of the color filter 1022.

Please refer to FIG. 2A, FIG. 2B and FIG. 2C. FIG. 2A is a diagram illustrating spectrums of the organic light-emitting diodes 202, 204 according to the prior art, FIG. 2B is a diagram illustrating locations of white points generated by the organic light-emitting diodes 202, 204 through a pigment based photoresist of the prior art in a CIE 1931 xy chromaticity diagram, and FIG. 2C is a diagram illustrating x coordinates and y coordinates of the white points of FIG. 2B. As shown in FIG. 2A, the spectrum of the organic light-emitting diode 202 has a first local maximum MAX1202 between 400 nm and 500 nm, and a second local maximum MAX2202 between 550 nm and 700 nm. The organic light-emitting diode 204 has a first local maximum MAX1204 between 400 nm and 500 nm. As shown in FIG. 2B and FIG. 2C, color gamut generated by the organic light-emitting diode 202 through the pigment based color filter matches a 72% specification of the National Television System Committee (NTSC), but the x coordinate and the y coordinate of the white point generated by the organic light-emitting diode 202 through the pigment based color filter in the CIE 1931 xy chromaticity diagram cannot match 0.28 and 0.29, respectively. In addition, color gamut generated by the organic light-emitting diode 204 through the pigment based color filter cannot match the 72% specification of the National Television System Committee (NTSC), and the x coordinate and the y coordinate of the white point generated by the organic light-emitting diode 204 through the pigment based color filter in the CIE 1931 xy chromaticity diagram also cannot match 0.28 and 0.29, respectively.

Therefore, the color display utilizing the color filter and the organic light-emitting diode of the prior art cannot simultaneously satisfy the color gamut of the 72% specification of the National Television System Committee and the x coordinate and the y coordinate of the white point in the CIE 1931 xy chromaticity diagram being 0.28 and 0.29, respectively.

### SUMMARY OF THE INVENTION

An embodiment of the present invention provides a color display. The color display includes a display panel and an organic light-emitting diode. The display panel includes a color filter, where the color filter includes a red photoresist, a green photoresist, and a blue photoresist, where the blue photoresist is a dye base material. The organic light-emitting diode is used for providing a first light source for the display panel.

The present invention provides a color display. The color display utilizes a color filter of a dye base photoresist or a color filter of a hybrid photoresist and an organic light-emitting diode to solve color shift of a white point and insufficient color saturation. Therefore, an x coordinate and a y coordinate of the white point of the present invention in the CIE 1931 xy chromaticity diagram match 0.28 and 0.29 respectively, and color gamut generated by the organic light-emitting diode through the color filter also matches a 72% specification of the National Television System Committee.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a color display utilizing an organic light-emitting diode as a backlight source according to the prior art.

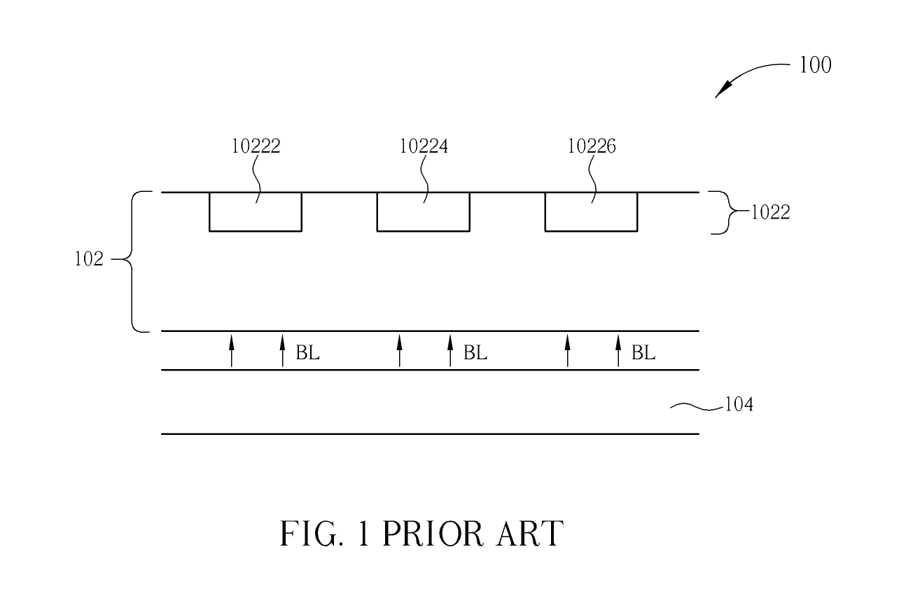

FIG. 2A is a diagram illustrating spectrums of the organic light-emitting diodes according to the prior art.

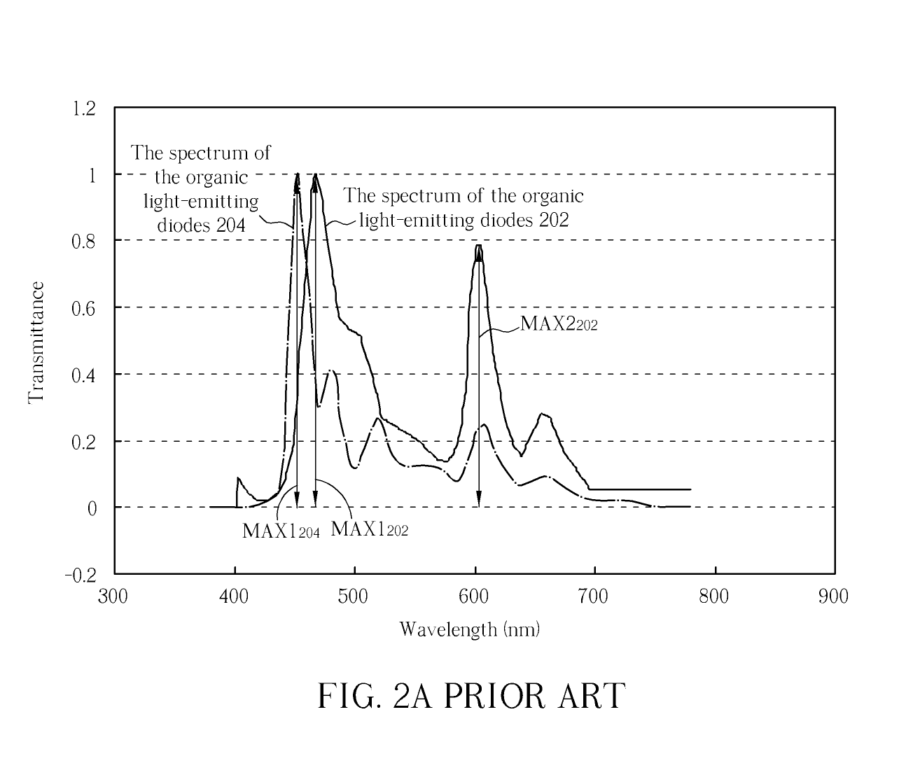

FIG. 2B is a diagram illustrating locations of white points generated by the organic light-emitting diodes with a pigment base photo resist of the prior art in the CIE 1931 xy chromaticity diagram.

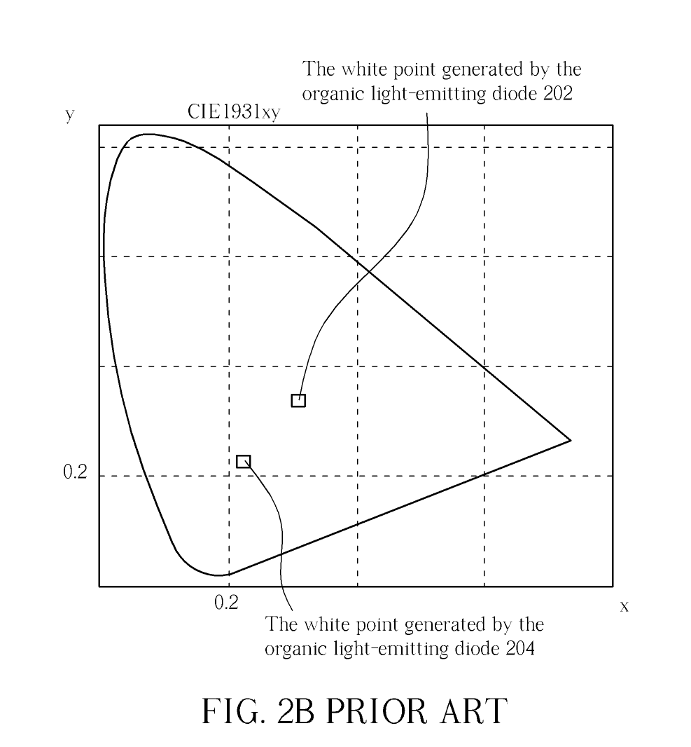

FIG. 2C is a diagram illustrating x coordinates and y coordinates of the white points of FIG. 2B.

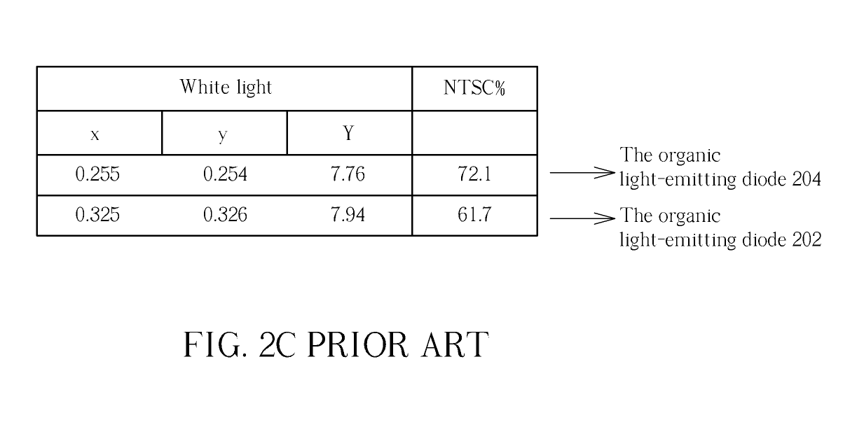

FIG. 3 is a diagram illustrating a color display according to an embodiment of the present invention.

FIG. 4A is a diagram illustrating a spectrum of the organic light-emitting diode.

FIG. 4B is a diagram illustrating a spectrum of the dye based blue photoresist and a spectrum of the pigment based blue photoresist.

FIG. 5 is a diagram illustrating a color display according to another embodiment of the present invention.

FIG. 6 is a diagram illustrating a spectrum of the hybrid blue photoresist and the spectrum of the pigment base blue photoresist.

### DETAILED DESCRIPTION

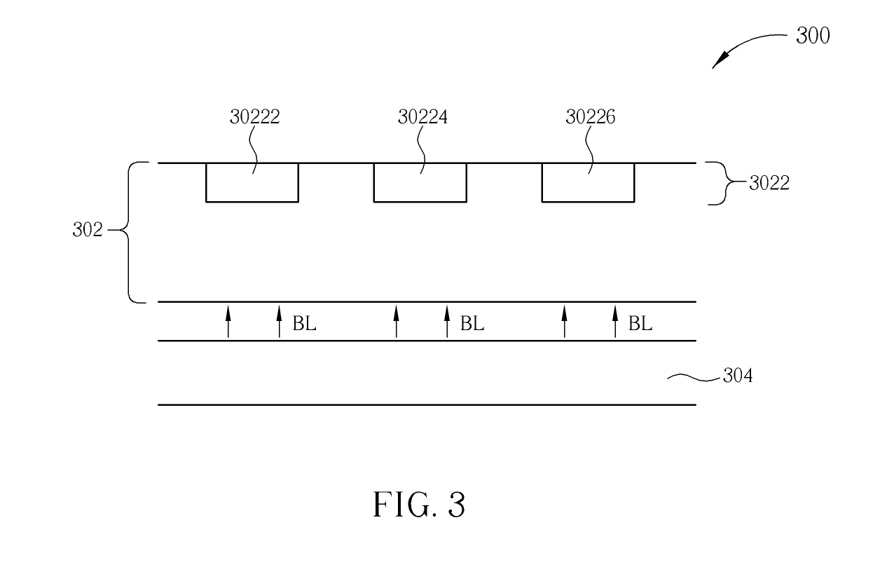

Please refer to FIG. 3. FIG. 3 is a diagram illustrating a color display 300 according to an embodiment of the present invention. The display 300 includes a display panel 302 and an organic light-emitting diode 304, where the display panel 302 includes a color filter 3022. The color filter 3022 is divided into a plurality of blocks; each block of the plurality of blocks corresponds to a pixel and includes a red photoresist, a green photoresist, and a blue photoresist, where the blue photoresist includes a dye based material, and the dye based material includes a violet dye. In addition, under the CIE standard C-light, an x coordinate of the blue photoresist in a CIE 1931 xy chromaticity diagram is between 0.13 and 0.15, and a y coordinate of the blue photoresist in the CIE 1931 xy chromaticity diagram is between 0.045 and 0.075. The organic light-emitting diode 304 is installed below the display panel 302 for providing backlight (white light) BL, where the backlight BL provides red light, green light, and blue light required by the display panel 302 through the color filter 3022. In another embodiment, the organic light-emitting diode 304 is installed on a side of the display panel 302. Further, FIG. 3 only shows a red photoresist 30222, a green photoresist 30224, and a blue photoresist 30226 of a block of the color filter 3022.

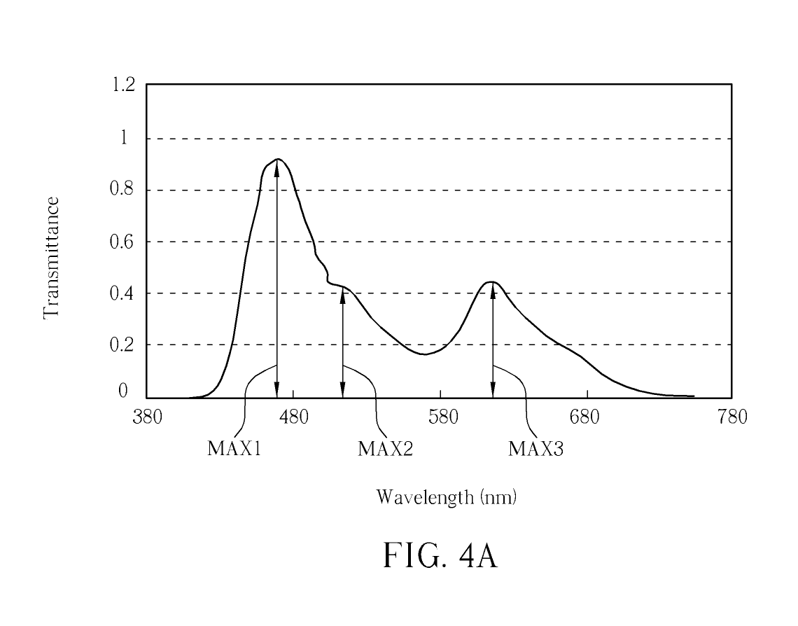

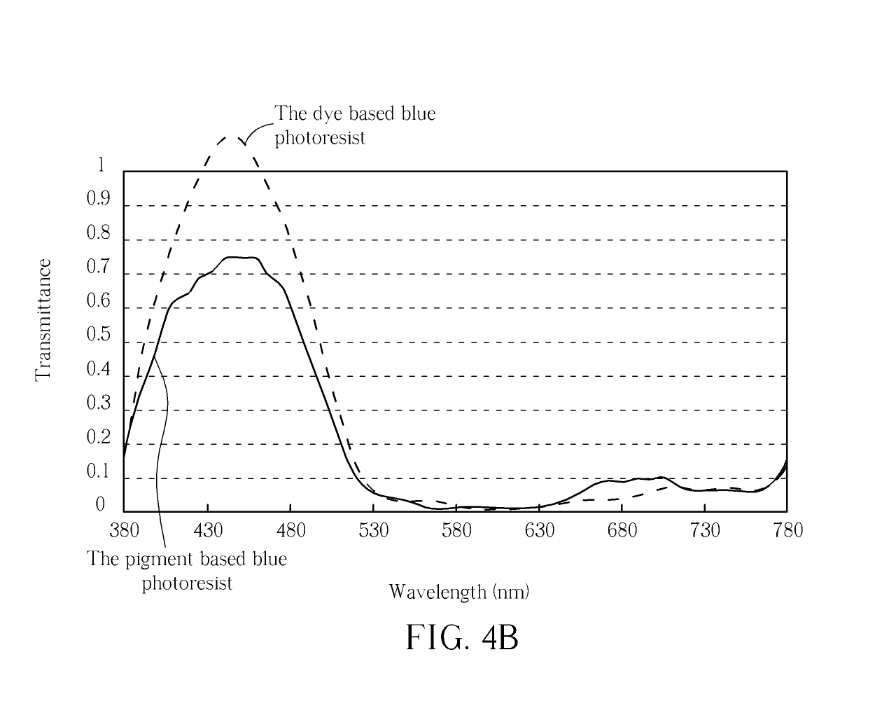

Please refer to FIG. 4A and FIG. 4B. FIG. 4A is a diagram illustrating a spectrum of the organic light-emitting diode 304. FIG. 4B is a diagram illustrating a spectrum of the dye based blue photoresist and a spectrum of the pigment based blue photoresist. As shown in FIG. 4A, the spectrum of the organic light-emitting diode 304 has a first local maximum MAXI between 400 nm and 500 nm, a second local maximum MAX2 between 500 nm and 580 nm, and a third local maximum MAX3 between 580 nm and 780 nm, where a ratio of the second local maximum MAX2 to the first local maximum MAX1 is between 0.4 and 0.5, and a ratio of the third local maximum MAX3 to the first local maximum MAXI is between 0.4 and 0.5. As shown in FIG. 4B, a transmittance of the dye based blue photoresist is higher than a transmittance of the pigment based blue photoresist. Therefore, when the backlight BL generates blue light through the color filter 3022, color saturation of the blue light is increased. In addition, the blue photoresist (dye based material) has high transmittance, so the blue photoresist can solve the color shift of a white point of the backlight BL. Thus, an x coordinate and a y coordinate of the white point generated by the organic light-emitting diode 304 through the color filter 3022 in the CIE 1931 xy chromaticity diagram match 0.28 and 0.29, respectively, and color gamut generated by the organic light-emitting diode 304 through the color filter 3022 also matches a 72% specification of the National Television System Committee (NTSC).

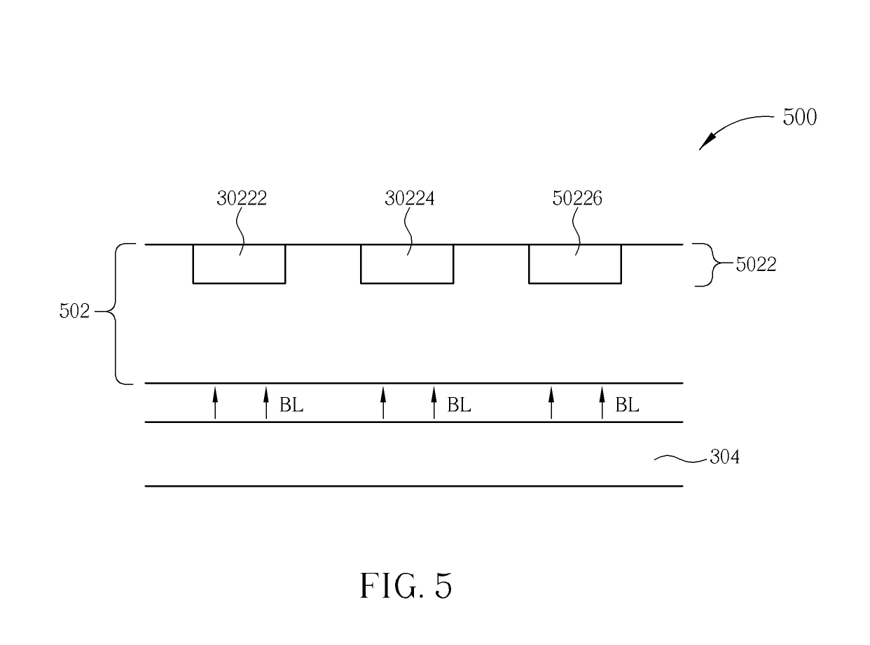

Please refer to FIG. 5. FIG. 5 is a diagram illustrating a color display 500 according to another embodiment of the present invention. The color display 500 includes a display panel 502 and an organic light-emitting diode 304, where the display panel 502 includes a color filter 5022. A difference between the color display 500 and the color display 300 is that a blue photoresist of the color filter 5022 is a hybrid photoresist, where the hybrid photoresist is composed of the dye based material and the pigment based material, and the pigment based material includes a PV23 pigment or a PB15 :6 pigment. In addition, under the CIE standard C-light, an x coordinate of the blue photoresist of the color filter 5022 in the CIE 1931 xy chromaticity diagram is between 0.13 and 0.15, and a y coordinate of the blue photoresist of the color filter 5022 in the CIE 1931 xy chromaticity diagram is between 0.045 and 0.075. FIG. 5 only shows the red photoresist 30222, the green photoresist 30224, and a blue photoresist 50226 of a block of the color filter 5022. Further, subsequent operational principles of the color display 500 are the same as those of the color display 300, so further description thereof is omitted for simplicity.

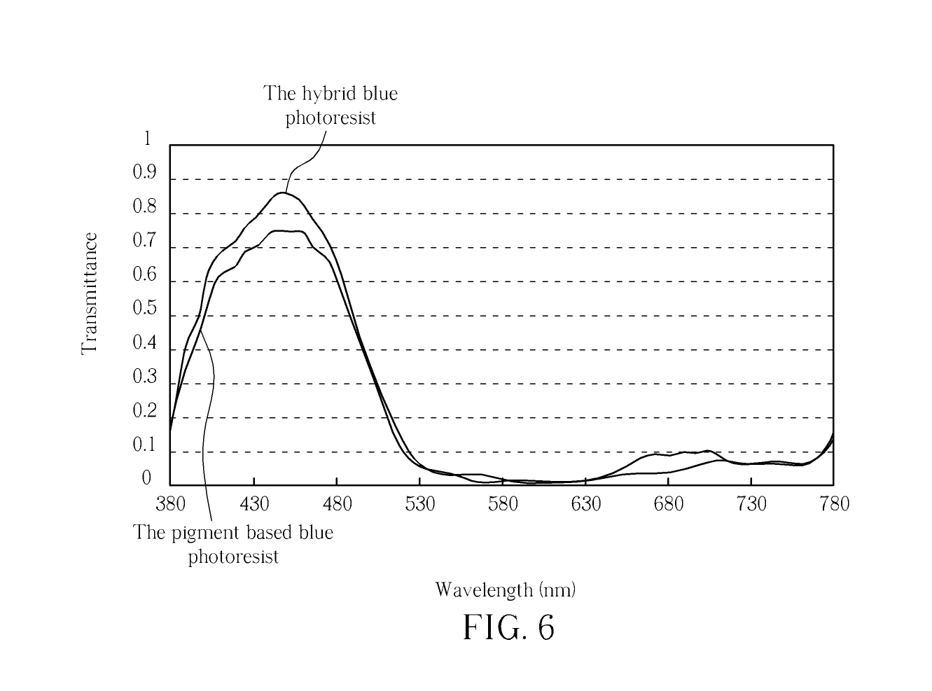

Please refer to FIG. 6. FIG. 6 is a diagram illustrating a spectrum of the hybrid blue photoresist and the spectrum of the pigment base blue photoresist. As shown in FIG. 6, a transmittance of the hybrid blue photoresist is higher than the transmittance of the pigment base blue photoresist. Therefore, when the backlight BL generates blue light through the color filter 5022, color saturation of the blue light is increased. In addition, the hybrid blue photoresist has high transmittance, so the hybrid blue photoresist can solve the color shift of the white point of the backlight BL. Thus, an x coordinate and a y coordinate of the white point generated by the organic light-emitting diode 304 through the color filter 5022 in the CIE 1931 xy chromaticity diagram match 0.28 and 0.29, respectively, and color gamut generated by the organic light-emitting diode 304 through the color filter 5022 also matches the 72% specification of the National Television System Committee.

To sum up, the color display provided by the present invention utilizes the color filter of the dye based blue photoresist or the color filter of the hybrid blue photoresist and the organic light-emitting diode to solve the color shift of the white point and the insufficient color saturation. Therefore, the x coordinate and the y coordinate of the white point of the present invention in the CIE 1931 xy chromaticity diagram can match 0.28 and 0.29, respectively, and the color gamut generated by the organic light-emitting diode through the color filter also matches the 72% specification of the National Television System Committee.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color display, comprising:
a display panel comprising:
a color filter comprising a red photoresist, a green photoresist, and a blue photoresist, wherein the blue photoresist comprises a dye base material; and
an organic light-emitting diode (OLED) for providing a first light source for the display panel.

2. The color display of claim 1, wherein the dye base material comprises a violet dye.

3. The color display of claim 1, wherein a spectrum of the first light source has a first local maximum between 400 nm and 500 nm, a second local maximum between 500 nm and 580 nm, and a third local maximum between 580 nm and 780 nm.

4. The color display of claim 3, wherein a ratio of the second local maximum to the first local maximum is between 0.4 and 0.5.

5. The color display of claim 3, wherein a ratio of the third local maximum to the first local maximum is between 0.4 and 0.5.

6. The color display of claim 1, wherein under CIE standard C-light, an x coordinate of the blue photoresist in the CIE 1931 chromaticity diagram is between 0.13 and 0.15, and a y coordinate of the blue photoresist in the CIE 1931 xy chromaticity diagram is between 0.045 and 0.075.

7. The color display of claim 1, wherein the first light source generates a second light source through the color filter, wherein color gamut of the second light source matches a 72% specification of the National Television System Committee (NTSC), and an x coordinate of a white point of the second light source in the CIE 1931 xy chromaticity diagram matches 0.28 and a y coordinate of the white point of the second light source in the CIE 1931 xy chromaticity diagram matches 0.29.

8. The color display of claim 1, wherein the blue photoresist further comprises a pigment base material.

9. The color display of claim 8, wherein the pigment base material comprises a PV23 pigment or a PB15:6 pigment.

10. The color display of claim 8, wherein a spectrum of the first light source has a first local maximum between 400 nm and 500 nm, a second local maximum between 500 nm and 580 nm., and a third local maximum between 580 nm and 780 nm.

11. The color display of claim 10, wherein a ratio of the second local maximum to the first local maximum is between 0.4 and 0.5.

12. The color display of claim 10, wherein a ratio of the third local maximum to the first local maximum is between 0.4 and 0.5.

13. The color display of claim 8, wherein under CIE standard C-light, an x coordinate of the blue photoresist in the CIE 1931 chromaticity diagram is between 0.13 and 0.15 and a y coordinate of the blue photoresist in the CIE 1931 xy chromaticity diagram is between 0.045 and 0.075.

14. The color display of claim 8, wherein the first light source generates a second light source through the color filter, wherein color gamut of the second light source matches a 72% specification of the National Television System Committee (NTSC), and an x coordinate of a white point of the second light source in the CIE 1931 xy chromaticity diagram matches 0.28 and a y coordinate of the white point of the second light source in the CIE 1931 xy chromaticity diagram matches 0.29.
